(19) United States
(12) Patent Application Publication
(10) Pub. No.: US 2023/0281918 A1
(43) Pub. Date: Sep. 7, 2023

(54) VIEWABILITY TESTING IN THE PRESENCE OF FINE-SCALE OCCLUDERS

(71) Applicant: Bidstack Group PLC, London (GB)

(72) Inventors: Arvids KOKINS, London (GB); Francesco PETRUZZELLI, London (GB)

(21) Appl. No.: 17/687,404

(22) Filed: Mar. 4, 2022

(51) Int. Cl. G06T 15/40; G06T 15/20; G06T 7/50; A63F 13/525

(52) U.S. Cl. CPC G06T 15/405; G06T 15/20; G06T 7/50; A63F 13/525

(57) ABSTRACT

A system configured to determine an extent to which an object in a computer-generated scene is visible when viewed from a perspective of a virtual camera. Includes a point generator configured to generate, for each of a plurality of image frames in which the scene is rendered, a respective set of points distributed across a surface of the object. Includes a viewability testing module configured to determine, for each image frame, which points of the respective set of points are visible from the perspective of the virtual camera, and determine the extent to which the object is visible in dependence on which points of the respective set of points are determined to be visible in each of the plurality of image frames. The positions of at least some of the generated points relative to the surface of the object vary between the plurality of image frames.

### BACKGROUND OF THE INVENTION

### Field of the Invention

The present disclosure relates to determining an extent to which an object in a computer-generated scene is visible from a perspective of a virtual camera. The disclosure has particular, but not exclusive, relevance to determining an extent to which an object of interest is occluded by objects with fine-scale detail.

### Description of the Related Technology

The popularity of video games has risen meteorically, and the global video game industry is currently worth more than the music and film industries combined. In the early years of gaming, video game developers and associated entities made money through the sale of video games on physical media (laser discs and cartridges). Nowadays, video games are more often downloaded or even streamed onto a connected gaming device such as a personal computer (PC), games console or smartphone. Whilst this model still allows commercial entities to make money from the sale of video games, it is common for further revenue streams to be pursued based on the sale of advertising space, including advertising space within the video games themselves. In the context of video games, adverts may be presented to a user as part of a loading screen or menu, or alternatively may be rendered within a computer-generated environment during gameplay, leading to the notion of in-game advertising. For example, in a sports game, advertising boards within a stadium may present adverts for real-life products. In an adventure game or first-person shooting game, adverts for real-life products may appear on billboards or other objects within the game environment.

Revenue models based on the sale of advertising space are ubiquitous in the context of film and television, as well as for websites and social media applications. Advertisers are typically charged in dependence on the expected or actual reach of a given advert, or in other words the expected or actual number of “impressions” of the advert experienced by consumers. For television and film, an advertising fee may be negotiated in dependence on a number of showings of the advert and a predicted audience size for each showing. For a website or social media application, the advertising fee may be related to a number of page views or clicks. Distribution of an advert may then be controlled in dependence on these factors.

In the above cases, it is technically straightforward to predict and measure the number of advertising impressions experienced by users. For video games, the situation is different. Because different players will experience a given video game differently depending on actions taken by the players and/or random factors within the video game code, it is not generally possible to predict a priori the extent to which a given advert within a video game will be viewed, and therefore the number of impressions experienced by the player. In order for the advertising revenue model to be applied to in-game advertising, the visibility of an advert may therefore be measured in real time as a video game is played.

The data gathered from measuring the visibility of an advert may be used to determine an advertising fee or to control the distribution of the advert. The data may also be used to inform the advertising entity, the game developer, or a third party, of the effectiveness of the advert. In all of these cases, it is important to the entity receiving the measurement data that the measurement data is accurate and can be relied upon irrespective of the specific gaming scenario. Various factors affect the degree to which an in-game advert is experienced by a player of the video game, including: the duration of time that the advert is on screen; the size of the advert in relation to the total size of the screen or viewport; and the proportion of an advert which is visible within the screen or viewport. The visibility of the advert depends on whether and how much the advert extends outside the viewport, and whether any portion of the advert is occluded by objects appearing in the scene with the advert.

A known method of determining whether an in-game advert is occluded by objects in a computer-generated scene is based on raycasting or ray tracing, in which algebraic ray equations are determined for rays emanating from a virtual camera in a direction towards a set of points evenly distributed across the advert, and these equations are then used to determine whether any objects intersect with rays between the virtual camera and the points. Any point for which at least one such intersection exists is determined to be occluded from the perspective of the virtual camera.

It is desirable to keep the computational cost of occlusion testing low, in particular compared with the computational cost of rendering a scene, in order that the occlusion testing can be performed at a sufficiently high frequency to capture changing degrees of occlusion, without negatively impacting the performance of the gaming device. In order to achieve this, the number of points used for occlusion testing may be chosen to be considerably less than the number of pixels of display space occupied by the rendered advert (for example, less than 1%). In cases where an advert is occluded by an object with fine-scale detail, i.e. containing gaps on a scale comparable to or smaller than the spacing between the points, the extent to which the advert is determined to be occluded may depend strongly on the exact positions of the points, and may lead to erroneous results. The problem may be compounded in scenarios where the apparent motion of the occluding object(s) relative to the advert is negligible (for example when the virtual camera, the advert, and the occluding object(s) are stationary relative to one another), which is a common occurrence in many types of video game.

### SUMMARY

According to a first aspect of the disclosed technology, there is provided a system configured to determine an extent to which an object in a computer-generated scene is visible when viewed from a perspective of a virtual camera. The system includes a point generator and a viewability testing module. The point generator is configured to generate, for each of a plurality of image frames in which the scene is rendered from the perspective of the virtual camera, a respective set of points distributed across a surface of the object. The viewability testing module is configured to determine, for each of the plurality of image frames, which points of the respective set of points are visible from the perspective of the virtual camera, and to determine the extent to which the object is visible in dependence on which points of the respective set of points are determined to be visible in each of the plurality of image frames. The positions of at least some of the generated points relative to the surface of the object vary between the plurality of image frames.

The extent to which the object is determined to be visible may be referred to as a viewability estimate. Varying the positions of the points between image frames and using the determination of which points are visible from multiple frames mitigates the dependence of the viewability estimate on the point position and any loss of accuracy in the presence of one or more fine-scale occluding objects, particularly when the apparent motion of the occluding object(s) relative to the surface is negligible. The robustness of the viewability test is thereby improved. Varying the positions of the points may also reduce the number of points needed in each image frame to achieve a viewability estimate of comparable accuracy, thereby reducing computational cost.

The positions of at least some of the generated points relative to the surface of the object may vary between image frames in dependence on outputs of a random, pseudorandom, or quasi-random number generator. Randomizing the point positions in this way (rather than varying the point positions according to a simple pattern) makes it less likely for the variation of point positions to correlate with the apparent movement of an occluding object relative to the surface of the object being tested, which could otherwise mitigate the improvement in robustness.

The positions of the points generated over the entirety of the plurality of image frames may be substantially evenly distributed across the surface of the object. In such cases, for a large enough number of image frames, the viewability estimate will tend towards a value that would result from the number of points being as high as the number of pixels spanned by the object surface when viewed from the virtual camera).

The point generator may be configured to generate a set of initial points distributed substantially evenly across the surface of the object. For each of the plurality of image frames, determining the respective set of points may then include offsetting at least some of the initial points in directions parallel to the surface of the object, the offsetting varying between the plurality of image frames. The offsets may be the same or different for different points in the set. In any case, provided the offsets are not biased in any particular direction, the positions of the points generated over a sufficiently large number of image frames will be substantially evenly distributed across the surface of the object. Provided most of the offsets are comparable to or smaller than around half of the average distance between points, the density of points is approximately even across the surface for each image frame, meaning that fewer image frames are needed. If the offsetting varies in dependence on outputs of a random, pseudorandom, or quasi-random number generator, then the offsets are unlikely to correlate with the apparent movement of an occluding object relative to the surface of the object being tested.

The point generator may be configured to determine a plurality of regions distributed substantially evenly across the surface of the object, and for each of the plurality of image frames, generate a point within each of the determined regions, thereby to generate the respective set of points. Positions of the points generated within at least some of the determined regions may then differ between the plurality of image frames. In this way, the density of points is approximately even across the surface for each image frame. A given region may include a plurality of candidate positions, and the positions of points generated within the given region over the plurality of image frames may be determined by selecting the plurality of candidate positions in a predetermined order. The candidate positions may for example be arranged on a grid with indexed grid squares, which are visited in accordance with a predetermined sequence.

Each respective set of points may contain the same number of points as any other set of points. In this way, the contributions from the various image frames can be treated equally, in which case the extent to which the object is visible may be calculated based at least in part on a sum of the number of points determined to be visible across the plurality of image frames.

The system may further comprise a rendering engine configured to render the computer-generated scene from the perspective of the virtual camera for each of the plurality of image frames, the rendering comprising storing, in a depth buffer, depth map data corresponding to a depth map of at least part of the computer-generated scene and comprising depth map values at pixel locations spanning at least part of a field of view of the virtual camera. For each of the plurality of image frames, for each point of the respective set of points lying within said at least part of a field of view of the virtual camera, the viewability testing module may be configured to determine a respective depth map value for the point from the perspective of the virtual camera, and determine, using the depth map data stored in the depth buffer, whether the point is visible from the perspective of the virtual camera based on a comparison between the determined depth map value for the point and a corresponding one or more of the depth map values stored in the depth buffer. The use of depth buffer data for viewability testing after the rendering of a scene is computationally efficient, it can be performed in a highly parallelized manner using graphics processing hardware, and it advantageously ensures that the objects (e.g. polygons) used for viewability testing reliably correspond to the objects used for rendering. The method is widely compatible with video games of any genre provided that rasterization-based rendering is utilized, enabling game developers or third parties to incorporate such functionality into video games with minimum alteration to their video game code.

For each of the plurality of image frames, for each point of the respective set of points lying within at least part of a field of view of the virtual camera, the viewability testing module may be configured to generate a ray from the virtual camera through the point, and determine whether any object in the scene lies on the ray between the virtual camera and the point, thereby to determine whether the point is visible from the perspective of the virtual camera. This raycasting approach provides an alternative to the depth buffer method described above, which may be applicable in certain settings where the depth buffer is not applicable, for example where rasterization-based rendering is not utilized.

Determining the extent to which the object is visible may include accumulating, over the plurality of image frames, values proportional to a number of points determined to be visible in each image frame. In cases where the number of points is different for different frames, the sum may be a weighted sum. As an alternative, the viewability testing module may assign a region of the surface to each point, determine an area of the surface, or an area of the viewport space, taken up by each region, and sum the areas of the regions assigned to the visible points.

Determining which points of the respective set of points are visible from the perspective of the virtual camera may include discarding points in the respective set of points lying outside a field of view of the virtual camera, and determining which remaining points after the discarding are not occluded by further objects in the scene. This two-stage approach ensures that occlusion testing is not unnecessarily performed for points lying outside the field of view, and mirrors the order of operations in certain rendering pipelines, enabling the method to be implemented by means of an auxiliary rendering pipeline.

For each of the plurality of image frames, the point generator may be configured to generate a respective initial set of points distributed substantially evenly across the surface of the object, discard points in the respective initial set of points lying outside the field of view of the virtual camera, and offset any remaining points of the initial set of points in directions parallel to the surface of the object, thereby to generate the respective set of points. By performing the discarding prior to the offsetting, points initially within the field of view but offset beyond the field of view will not be discarded, and points initially outside the field of view but offset to within the field of view will be discarded. In this way, the varying of point positions is prevented from causing errors in the field of view test.

The point generator may be configured to offset the points from the surface of the object in a direction towards the virtual camera or in a substantially outward direction with respect to the surface of the object (e.g. in the direction of an exact/average normal to the surface). In this way, the viewability testing can be made robust against sampling errors caused by the finite size of pixels, limited precision computation, and/or discretization of the depth buffer (if the depth buffer is used for viewability testing), avoiding erroneous determinations of the object not being visible, for example where the surface of the object corresponds to at least a portion of one or more rendering primitives of the scene.

In cases where the point generator is configured to offset the points from the surface of the object, the offsetting may be by a distance that increases with distance of the point from the virtual camera. In certain settings the precision of the depth buffer reduces with distance from the virtual camera. Therefore, a greater degree of offsetting may be appropriate for greater distances from the virtual camera, in order to achieve the effect of avoiding erroneous determinations of the object not being visible.

The point generator may be prohibited from offsetting points to positions closer to the virtual camera than a near plane of the virtual camera. In this way, side effects in which points are moved into a region excluded by the field of view may be prevented. Such side effects may occur for example where the virtual camera is an orthographic camera and/or where information is presented in the foreground of the scene, for example in a user interface such as a heads-up display or dashboard. In such cases, a game developer may position objects in or very close to the near plane.

According to a second aspect, there is provided a computer-implemented method of determining an extent to which an object in a computer-generated scene is visible when viewed from a perspective of a virtual camera. The method includes generating, for each of a plurality of image frames in which the scene is rendered from the perspective of the virtual camera, a respective set of points distributed across a surface of the object, determining, for each of the plurality of image frames, which points of the respective plurality of points are visible from the perspective of the virtual camera, and determining the extent to which the object is visible in dependence on which points of the respective set of points are determined to be visible in each of the plurality of image frames. The positions of at least some of the generated points relative to the surface of the object vary between the plurality of image frames.

According to a third aspect, there is provided a non-transient storage medium comprising instructions which, when executed by a computer, cause the computer to carry out a method of determining an extent to which an object in a computer-generated scene is visible when viewed from a perspective of a virtual camera. The method includes generating, for each of a plurality of image frames in which the scene is rendered from the perspective of the virtual camera, a respective set of points distributed across a surface of the object, determining, for each of the plurality of image frames, which points of the respective plurality of points are visible from the perspective of the virtual camera, and determining the extent to which the object is visible in dependence on which points of the respective set of points are determined to be visible in each of the plurality of image frames. The positions of at least some of the generated points relative to the surface of the object vary between the plurality of image frames.

### BRIEF DESCRIPTION OF THE DRAWINGS

FIG. 1 schematically shows functional components of a system in accordance with examples.

FIGS. 2A-2C show examples of different sets of points distributed across a partially-occluded surface of an object.

FIG. 3 is a flow diagram representing a computer-implemented method of viewability testing according to examples.

FIG. 4 is a flow diagram showing a first possible implementation of the computer-implemented method of FIG. 3.

FIG. 5 shows examples of point positions randomized over a sequence of image frames.

FIG. 6 is a flow diagram showing a second possible implementation of the computer-implemented method of FIG. 3.

FIG. 7 shows an example of candidate point positions within a region of a surface.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further notes that certain examples are described schematically with certain features omitted and/or necessarily simplified for the ease of explanation and understanding of the concepts underlying the examples.

Embodiments of the present disclosure relate to determining an extent to which an object is visible from a perspective of a virtual camera within a computer-generated environment such as a video game environment. In particular, embodiments described herein address the problem of reduced accuracy of viewability testing methods in the presence of occluding objects with fine-scale detail, and can therefore improve the robustness of such methods.

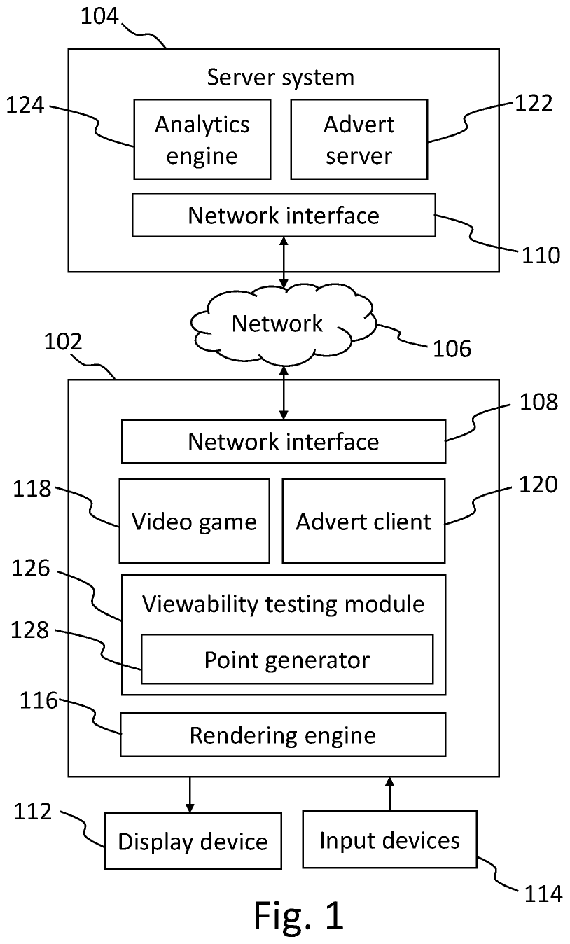

FIG. 1 schematically shows functional components of a gaming device 102 and a server system 104 arranged to communicate over a network 106 using respective network interfaces 108, 110. The various functional components shown in FIG. 1 may be implemented using software, hardware, or a combination of both. The gaming device 102 can be for example any electronic device capable of processing video game code to output a video signal to a display device 112 in dependence on user input received from one or more input devices 114. The video signal typically includes a computer-generated scene rendered on a frame-by-frame basis in real time by a rendering engine 116, for example using rasterization-based rendering techniques and/or raycasting techniques. The rendering engine 116 may be configured to render the three-dimensional model in dependence on values of one or more parameters of a virtual camera. The parameters of the virtual camera may control a position and orientation of the virtual camera relative to the scene, along with an angle or angles subtended by a field of view of the virtual camera. The values of these parameters determine which regions of the scene are rendered in a given image frame, along with their respective positions, orientations, and scales. Depending on the video game 118, the virtual camera may be a perspective camera, an orthographic camera, or a camera arranged to render the scene based on any other suitable form of projection. The virtual camera may be controllable by user actions received via the input devices 114, or may be fixed or move in an automated manner.

The gaming device 102 may for example be a personal computer (PC), a laptop computer, a tablet computer, a smartphone, a games console, a smart tv, a virtual/augmented reality headset with integrated computing hardware, or a server system arranged to provide cloud-based gaming services to remote users (in which case the display device 112 and the input devices 114 may be connected to the gaming device 102 over a network). It will be appreciated that the gaming device 102 may include additional components not shown in FIG. 1, for example additional output devices such as audio devices and/or haptic feedback devices.

The server system 104 may be a standalone server or may be a networked system of servers, and in this example is operated by a commercial entity responsible for managing the distribution of adverts to end users (gamers) on behalf of advertisers, though in other examples an equivalent or similar system may be operated directly by an advertiser.

The gaming device 102 may be arranged to store a video game 118 locally, for example after downloading the video game 118 over the network 106, or may be arranged to read the video game 118 from a removable storage device such as an optical disc or removable flash drive. The video game 118 may be purchased by a user of the gaming device 102 from a commercial entity such as a games developer, license holder or other entity, or may be obtained for free, via a subscription model, or in accordance with any other suitable revenue model. In any of these cases, the commercial entity may obtain additional revenue by selling advertising space within the video game 118 to advertising entities, either directly or via a third party. For example, a video game developer may allocate particular objects, surfaces, or other regions of a scene within the video game 118 as advertising space, such that advertisements appear within said regions when the scene is rendered during gameplay.

The rendered advertisements may be static images or videos and may be dynamically updated as the user plays the video game 118, for example in response to certain events or certain criteria being satisfied. Furthermore, the rendered advertisements may be updated over time, for example to ensure that the rendered advertisements correspond to active advertising campaigns, and/or in dependence on licensing agreements between commercial entities. The advertisements for rendering are managed at the gaming device 102 by an advert client 120, which communicates with an advert server 122 at the server system 104. For example, the advert server 122 may transmit advert data to the advert client 120 periodically or in response to predetermined events at the gaming device 102 or the server system 104.

In addition to the advert server 122, the server system 104 includes an analytics engine 124 configured to process impression data received from the gaming device 102 and other gaming devices registered with the server system 104. The impression data may include, inter alia, information regarding how long, and to what extent, an advertisement is visible to users of the gaming devices. The impression data may include information at various levels of detail, for example a simple count of advertising impressions as determined in accordance with a given metric, or more detailed information such as how long a given advertisement is visible to a user during a session, the average on-screen size of the advertisement during that time, and the proportion of the advertisement that is visible during that time.

The analytics engine may process the impression data for a variety of purposes, for example to match a number of advertising impressions with a number agreed between the distributing party and the advertiser, to trigger the advert server 122 and/or the advert client 120 to update an advert appearing within the video game 118, or to determine a renumeration amount to be paid by the advertiser. It will be appreciated that other uses of impression data are possible, though a detailed discussion of such uses is outside the scope of the present disclosure.

In order to generate impression data for processing by the analytics engine 124, the gaming device 102 includes a viewability testing module 126. The viewability testing module 126 is responsible for determining the extent to which an advertisement located within a scene is visible when the scene is rendered by the rendering engine 116 from a perspective of a virtual camera. In particular, the viewability testing module 126 is responsible for detecting when an advert appearing within a rendered scene is occluded by other objects in the scene. In order to perform these tasks in a computationally efficient manner, the viewability testing module 126 is configured to determine, for a given rendered image frame, whether each of a set of points distributed across a surface of the advertisement is visible from the perspective of the virtual camera, and to determine the extent to which the advertisement is visible based on which points are determined to be visible over multiple image frames.

The viewability testing module 126 includes a point generator 128 for generating sets of points to be used for viewability testing. In accordance with the present disclosure, the point generator 128 is arranged to regenerate the points in between image frames such that the positions of at least some the points relative to the surface of the object vary between the image frames. As will be explained in more detail hereinafter, this can improve the robustness of the viewability testing, in particular in the presence of occluding objects with fine-scale detail.

It will be understood that, whilst the viewability testing module 126 and point generator 128 are shown separately from the video game 118 in FIG. 1, the functionality of the viewability testing module 126 and the point generator 128 may in fact be defined within the video game 118, for example as code written by the game developer or provided by the operator of the server system 104 to the game developer as part of a software development kit (SDK).

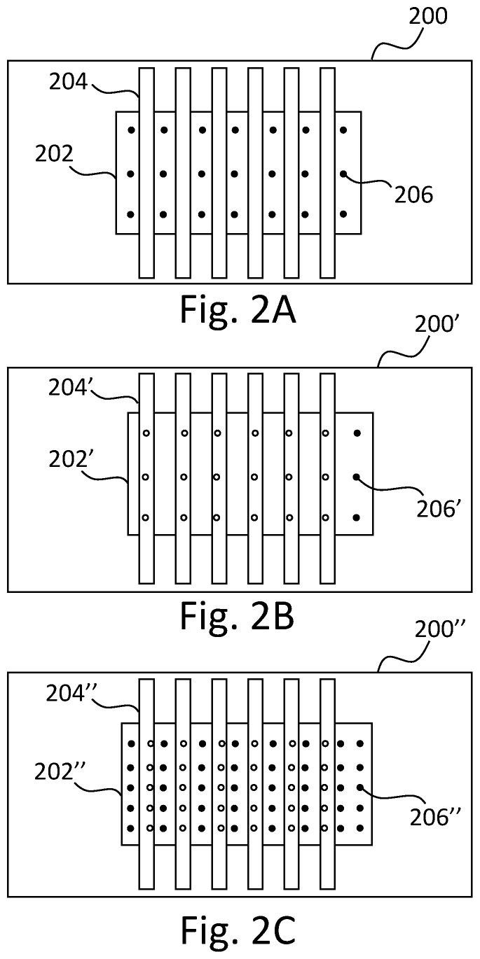

FIG. 2A shows an example of an image frame 200 containing a scene rendered from a perspective of a virtual camera. The scene includes a rectangular surface 202 partially occluded or obstructed by six pillars 204 evenly spaced from one another. In order to determine the extent to which the surface 202 is visible from the perspective of the virtual camera, a set of twenty-one points 206 is shown distributed substantially evenly across the surface 202. It is to be noted that for practical implementations the points 206 may not be rendered with the scene and would not be visible to the user, and are shown in FIG. 2A for illustrative purposes only. In this example, the width of the pillars 204, and the size of the spacing between the pillars 204, is comparable to the spacing between the points 206, such that the pillars 204 can be described as having detail on a comparable scale to the spacing between the points 206. In this example, it is observed that despite a significant portion of the surface 202 being occluded by the pillars 204, none of the points 206 are occluded, and accordingly all of the twenty-one points 206 are visible from the perspective of the virtual camera (the visible points 206 are represented as solid circles). Using the set of points 206, a points-based viewability testing method would therefore determine that the visibility of the surface 202 is 21/21=100% in the frame 200.

FIG. 2B shows a second image frame 200′ in which a rectangular surface 202′ is partially occluded by six pillars 204′. A set of points 206′ is substantially evenly distributed across the surface 202′. The dimensions of the surface 202′ and the pillars 204′ are identical to the dimensions of the surface 202 and the pillars 204 of the frame 200, and therefore the degree to which the surface 202′ is occluded in the frame 200′ is identical to the degree to which the surface 202 is occluded in the frame 200. Furthermore, the spacing of the points 206′ is identical to the spacing of the points 206. The only difference between the two frames 200 and 200′ is that the surface 202′ and the points 206′ in the frame 200′ appear slightly to the right of where the surface 202 and the points 206 appear in the frame 200. However, in the frame 200′, only three of the twenty-one points 206′ (represented as solid circles) are visible from the perspective of the virtual camera, whereas eighteen of the twenty-one points 206′ (represented as empty circles) are occluded by the pillars 204′ and therefore not visible from the perspective of the virtual camera. A points-based viewability testing method would therefore determine that the visibility of the surface 202′ is 3/21=14% in the frame 200′.

FIGS. 2A and 2B demonstrate that, in situations where occluding object(s) have detail on a scale or spatial frequency comparable or smaller to the spacing between points, the results of points-based viewability testing methods are strongly influenced by the exact position of the points in relation to the occluding object(s). As such, the result may be strongly affected by relatively minor changes in the scene (as shown between FIGS. 2A and 2B), and/or by the exact positions of the points with respect to the surface 202 across which the points are distributed. In this example, the actual proportion of the surfaces 202, 202′ visible from the perspective of the virtual camera is around 60%, further demonstrating that in both cases the result achieved using points-based methods is highly erroneous. For this reason, points-based viewability testing methods are not robust in the presence of fine-scale occluding objects. The issue may be particularly pronounced in cases where the apparent motion of the occluding object(s) relative to the advert is negligible, for example when the scene is static or for distant objects for which may appear to have negligible motion even when the perspective of the virtual camera moved relative the scene. Such situations are common in many video games, for example when a player is stationary in a first person shooting game, adventure game or the like, or where a fixed camera is used or the camera remains stationary within a game environment for a prolonged period of time.

FIG. 2C shows a third image frame 200″ which is identical to the second image frame 200′ of FIG. 2B. However, in this example a set of seventy points 206″ is distributed substantially evenly across the surface 202″ for use in viewability testing. Due to the increased spatial density of the points 206″, the spacing between the points 206″ is smaller than the width of the pillars 204″ and the spacing between the pillars 204″. In this example, forty of the seventy points 206″ (represented as solid circles) are visible from the perspective of the virtual camera, and thirty of the points 206″ (represented as hollow circles) are occluded by the pillars 204″. In this example, a points-based viewability testing method would determine that the visibility of the surface 202″ is 40/70=57% in the frame 200″. This result is far more accurate than the results of FIGS. 2A and 2B, demonstrating that an effective way to increase the accuracy of a points-based viewability testing method is to ensure that the spacing between points is smaller than the scale of the detail of the occluding object(s). However, in many practical applications, it may not be practicable to ensure this will be the case for all possible occluding objects in a game, particularly where the viewability testing is implemented to be compatible with a range of different video games (for example as part of an SDK). Even if it were possible to know the sizes of all possible occluding objects, certain objects may have detail on a very small scale (thin branches of a tree, swarms or clouds of small or particulate objects, and so on). In this case, a very high density of points would be required to ensure accurate results, which would significantly increase the computational cost of the viewability testing, which may negatively impact the performance of the gaming device. It is highly desirable that in-game advertising does not negatively affect the gaming experience.

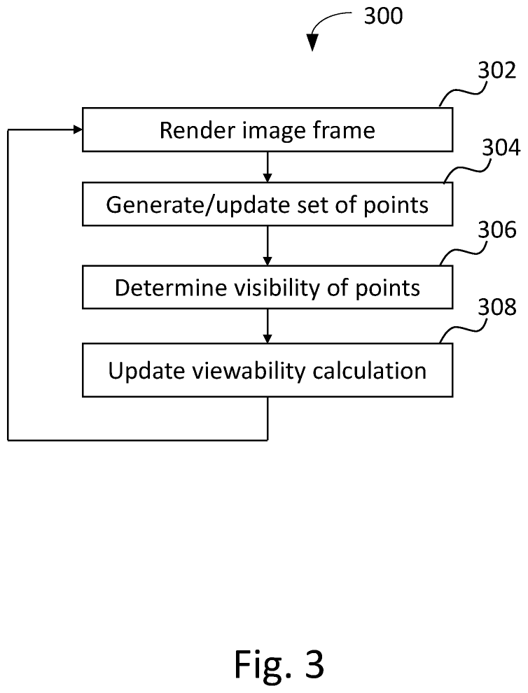

FIG. 3 shows an example of a computer-implemented method 300 of determining an extent to which an object in a computer-generated scene is visible when viewed from a perspective of a virtual camera, which addresses the problem described above. The object may be a three-dimensional object or a two-dimensional object, and will generally have at least one surface potentially visible from the perspective of the virtual camera. The object may for example be an advertisement surface or other surface, in which case the object may be formed of one or more flat two-dimensional surface sections, or the object may be a three-dimensional object having one or more curved or flat surfaces or surface sections. The extent to which the object is determined to be visible may be referred to as a viewability estimate, which may refer to a proportion of the object that is visible, or to a proportion of the viewport occupied by visible portions of the object. The viewability estimate may be calculated for example as an average over a period in which at least part of the object is visible, or as a fixed or moving average over a predetermined number of image frames. In another example, the viewability estimate may take the form of a cumulative score which increases over time.

The method 300 includes rendering, at 302, an image frame from the perspective of the virtual camera. The rendering may be performed using rasterization-based techniques, ray-tracing, and/or any other suitable rendering technique(s). The rendering may be based on a graphics pipeline including an application stage, a geometry stage, and a rasterization stage, though alternative graphics pipelines are possible, for example incorporating ray tracing for at least some aspects of the scene. During the application stage, a set of rendering primitives is obtained for a set of models forming the scene. The rendering primitives generally include points, lines, and polygon meshes which collectively represent objects. During the geometry stage, coordinates of the rendering primitives are transformed from “model” space to “world” space to “view space” to “clip” space, in dependence on a position and orientation (pose) of the models in the scene, and a pose of the virtual camera. Some primitives may be discarded or clipped, for example primitives falling completely or partially outside the field of view of the virtual camera or outside a predetermined guard band extending beyond the field of view of the virtual camera, along with optionally any facing away from the virtual camera, after which the coordinates of surviving primitives are scaled to “normalized device coordinates (NDC)” such that the NDC values for primitives (or portions of primitives) to be displayed within the viewport fall within a predetermined range (usually [−1;1]). Furthermore, depth bias may be introduced to certain polygons to ensure that coplanar polygons (for example representing a surface and a shadow on the surface) are rendered correctly and independently of the rendering order. The resulting output is then scaled to match the size of the viewport in which the scene is to be rendered. The viewport may correspond to the entire display of a display device, or may correspond to only a portion of a display device for example in the case of split-screen multiplayer, a viewport presented within a decorated frame, or a virtual screen within the computer-generated scene. During the rasterization stage, discrete fragments are determined from the rendering primitives, where the size and position of each fragment corresponds to a respective pixel of a frame buffer/viewport. A depth buffer is used for determining which fragments are to be written as pixels to the frame buffer, and at least the fragments to be written to the frame buffer are colored using texture mapping techniques in accordance with pixel shader code. To avoid redundant processing, some video games use a separate initial rendering pass that writes only to the depth buffer, then perform further rasterization steps in a subsequent rendering pass, filtered by the populated depth buffer. Lighting effects may also be applied to the fragments, and further rendering steps such as alpha testing and antialiasing may be applied before the fragments are written to the frame buffer and screen thereafter.

The virtual camera may for example be a perspective camera in which a three-dimensional environment is projected onto a display from a point (as is common in a wide range of three-dimensional games), or may be an orthographic camera in which projection lines are orthogonal to the display such that a given plane within the scene is transformed to the display according to an affine transformation. The rendered image frame contains a view of a scene, which may be three-dimensional or “two-and-a-half dimensional”, also known as “pseudo-three-dimensional”, in which two-dimensional graphical projections are used to simulate the appearance of three-dimensions. The image frame may be a single image containing a two-dimensional view of the scene or may be formed of a pair of images containing views from slightly different perspectives representing a stereoscopic view of the scene (as may be the case for example in virtual reality or augmented reality applications). In any of these cases, objects appearing within the scene may be occluded by other objects such that they are not visible from the perspective of the virtual camera. In the case of a stereoscopic view, an object or part of an object may be defined as being occluded if the object is obstructed from view in both images of the stereoscopic pair, or alternatively if the object is obstructed from view in at least one of the images of the stereoscopic pair.

The method 300 proceeds with generating, at 304, a set of points distributed across a surface of the object. The surface may be flat or curved, and may be of any dimensions or geometry for example a quadrilateral or any other polygon or other shape. The surface may be formed of several surface sections (for example flat surface sections), in which case a respective set of points may be generated for each of the surface sections. The surface may be formed of one or more rendering polygons, and the points may be generated directly from the one or more rendering polygons. Alternatively, and advantageously, the points may be generated across one or more test polygons which match or approximate the one or more rendering polygons (where matching is possible for coplanar rendering polygons, and approximating is possible for approximately coplanar rendering polygons, for example rendering polygons modelling a rough or uneven surface which fluctuates about a plane). The test polygons may be provided as part of the code of the video game 118, or alternatively may be generated automatically by the gaming device 102, e.g. during loading of the scene, based on an algorithm which averages or otherwise takes into account the orientations of the relevant rendering polygons, and optionally texture coordinates for the surface in the case that the surface does not completely cover the rendering polygons (this may be useful when the polygons of the scene cannot be predetermined, such as may be the case for a procedural mesh). If the number of test polygons is less than the number of rendering polygons, the generating of the points will be performed more quickly and at a lower computational cost than if the rendering polygons were used directly, improving the responsiveness of the viewability testing procedure whilst also reducing processing demands, without having an adverse effect on graphics performance.

It is noted that, whilst in FIG. 3 the generating of points is shown after the rendering of an image frame (scene), in examples the set of points may be generated in parallel with the rendering of the scene, for example using a CPU or other host circuitry whilst a GPU performs at least part of the rendering process. Generating the set of points may involve determining world co-ordinates of each point, given a set of world co-ordinates associated with the surface of the object (such as co-ordinates of its vertices) or a matrix representing a transformation from a default surface to the position and orientation of the surface in world space.

The set of points generated at 304 may be substantially evenly distributed across the surface of the object, such that the in-plane spacing between the points is substantially equal, though this is not essential as will be explained in more detail hereinafter. The set of points may extend across the entire surface, for example to the edges of the surface or with a small border region in which no points are located. The set of points may be generated directly in world space based on coordinates of one or more vertices or other parts of the surface in world space, or alternatively coordinates may be determined in model space or in a two-dimensional “surface space” in the case of a flat surface, then transformed to world space using a suitable transformation matrix. As a further option, coordinates may be determined in a default box [0;1]2, then used as factors to interpolate between the vertices of the surface in world space.

The method 300 proceeds with determining, at 306, which of the points of the set of points generated at 304 are visible from the perspective of the virtual camera. A point may be considered visible if the point lies within the first of view of the virtual camera (e.g. within the viewing frustum in the case of a perspective camera) and is not occluded by any other object in the scene. Accordingly, determining whether a point is visible may include a field of view test to determine whether the point lies within the field of view of the virtual camera, and a point occlusion test to determine whether the point is occluded by any other object(s) within the scene.

The field of view test may include discarding any point lying outside the field of view of the virtual camera, and then the point occlusion test may be performed for points which remain after the discarding. The field of view test may involve discarding points which lie outside the viewing frustum of the virtual camera (in the case of a perspective camera). Furthermore, points corresponding to any surface for which predetermined viewability criteria are not satisfied may be discarded. Examples of viewability criteria include more than a predetermined proportion of the surface (such as 30%, 50%, or 70%) lying within the field of view of the virtual camera, the surface having a projected area greater than a predetermined proportion of the viewport area (such as 1%, 2%, or 5%), or an angle between the outward-facing normal vector of the surface and an axial direction towards the camera being less than a predetermined angle (such as 45°, 60° or 75°). Points corresponding to surfaces facing away from the user may be automatically discarded in this way.

The point occlusion test may be performed for example using raycasting, in which a ray is generated from the virtual camera through the point on the surface of the object, and a determination is made whether any object in the scene lies on the ray between the virtual camera and the point. More specifically, assuming the candidate occluding objects are convex polygons, the point occlusion test may be performed using a two-part ray-polygon test for at least a subset of the polygons in the scene, which first involves a ray-plane test which checks whether the polygon is not coplanar with the ray and is in front of the ray, and if so generates an intersection point between the ray and the plane of the polygon. If the intersection is not further from the camera than the point being tested, a point-in-polygon test is performed to determine whether the intersection point lies within the polygon (this may be performed by testing the point against all edge planes of the polygon or alternatively by determining barycentric coordinates for the intersection and using a barycentric coordinate test if the polygon is a triangle).

An alternative to ray tracing uses depth buffer information stored during rendering of the scene by a rasterization-based rendering method. An example of a suitable method for point occlusion testing involves, for each of the generated points lying within a field of view of the virtual camera, determining a respective depth map value from the perspective of the virtual camera, then comparing the respective depth map value for the point with a corresponding one or more of the depth map values stored in the depth buffer during rendering of the scene, to determine whether the point is visible from the perspective of the virtual camera. Using this method, the point occlusion test (as well as the field of view test) may be performed at least partially within a GPU, for example via an auxiliary rendering process which produces no visible output on the display.

The method 300 proceeds by updating, at 308, a viewability calculation for use in determining the viewability estimate for the object. In an initial iteration of the method 300, for example in which the object first appears in the field of view of the virtual camera, the viewability calculation may be zero and may be updated to a value proportional to the number of points determined to be visible from the perspective of the virtual camera. As mentioned above, the viewability estimate may refer to an average proportion of the object that is visible from the perspective of the virtual camera, or to an average proportion of the viewport occupied by visible portions of the object. The viewability calculation may therefore involve determining these proportions on a frame-by-frame basis and taking an average over multiple frames. In examples where the viewability estimate is defined as the proportion of the object that is visible, the viewability calculation may alternatively involve accumulating the number of visible points over multiple frames and dividing by the number of points generated over those frames to arrive at the viewability estimate. In examples where the viewability estimate is a cumulative score, the viewability calculation may involve accumulating, over multiple frames, values proportional to the number of visible points in those frames.

The proportion of the object that is visible in a given image frame may be calculated for example by (i) dividing the number of visible points by the number of generated points, or (ii) dividing the number of visible points by the number of points within the field of view of the virtual camera, and multiplying the result by the proportion of the area of the surface lying within the field of view of the virtual camera. The proportion of the viewport occupied by visible portions of the object in a single image frame may be calculated by dividing the number of visible points by the number of points within the field of view of the virtual camera, and multiplying the result by the projected area of the (clipped) surface in NDC space divided by the total area of the field of view in NDC space (which is 4, assuming NDC space is normalized to [−1,1]). It will be appreciated that alternative calculations may be performed to arrive at the same result.

The method 300 may return to 302, in which a further image frame is rendered as described above. The method continues by generating, at 304, an updated set of points distributed substantially evenly across the surface of the object. The positions of at least some of the points in the updated set of points relative to the surface of the object differ from those of the previously-generated set of points. The updated set of points may include the same number of points as the previous set of points, though this is not essential. The positions of some or all of the points may for example be offset compared with the previous set, or an entirely new set of points may be generated. For example, the previous set of points may be arranged on a particular grid, for example a rectilinear grid, a triangular grid, or any other type of Bravais or other lattice. The updated set of points may then be arranged on a different grid.

The method 300 continues with updating, at 308, the viewability calculation for use in determining the viewability estimate for the object. Depending on how the viewability estimate is defined, updating the viewability calculation may include updating an average or adding to a cumulative value.

The method 300 may continue iteratively, with positions of at least some of the generated points relative to the surface of the object varying between iterations. The viewability calculation is updated at each iteration and, if necessary, a final division operation can be applied to determine the final viewability estimate, for example after the object ceases to be visible from the perspective of the virtual camera. By using results from multiple frames, with the positions of the points varying between the frames, the viewability testing method can effectively sample the detail of occluding objects to arrive at an accurate viewability estimate without requiring the inter-point distances to be small compared with the scale of the detail.

The positions of the points may be updated at every iteration, or alternatively may be updated only for some iterations. In this way, the varying of the point positions may be performed at the same or a lower frequency than the viewability testing. However, for the varying of point positions to provide the benefits of improved accuracy of viewability testing, the positions of the points should be varied on a timescale shorter than the typical time it takes a human to perceive an object. In this way, for any object displayed long enough to potentially be registered by the user (e.g. to cause an impression in the case of an advert), the point positions will vary several times. Advantageously, the characteristic speed at which the points move between frames, given approximately by the average offset distance per frame multiplied by the frequency at which the point positions are updated, may be significantly higher than the typical speed at which occluding objects move within the scene, such that the motion of occluding objects does not strongly affect the accuracy of the viewability estimate. This typical speed may differ between use cases (for example, between different video games), and an implementation which updates the point positions at the same frequency as the viewability testing, and preferably at the same frequency as the scene is rendered, is expected to be suitable for any use case.

Although the positions of the points vary between image frames, the positions of all of the points generated over several iterations may be substantially evenly distributed across the surface of the object. In this way, contributions to the viewability estimate from different regions of the surface are equally weighted when taken over a sufficient number of image frames. Even in cases where the positions are not substantially evenly distributed across the surface of the object, it is desirable that, when averaged over several frames, the density of points is approximately even across the surface. In some examples, the positions of the points at each iteration may be substantially evenly distributed, for example with all of the points being offset by a common in-plane vector between image frames. In other examples, the positions of the points in each generated set may be unevenly distributed, but their union over a sufficient number of frames may be substantially evenly distributed or at least have a density which is approximately even across the surface. In any case, the accuracy of the viewability estimate is expected to increase with the number of image frames over which the point positions are varied, and it is therefore desirable for the timescale on which the points are varied to be high compared with the typical time taken for a human to perceive an object. The positions of the points may be updated several times a second, for example more than five, ten, twenty or fifty times per second.

The positions of the points may vary according to a predetermined pattern, or the positions of the points in each set may be substantially independent of the positions of the points in any previously-generated set. It is preferable that the positions do not vary according to a pattern which is too simple and regular. A pattern which is too simple and regular may result in the variation of point positions accidentally correlating with the apparent motion of an occluding object relative to the surface of the object being tested. In this case, fine-scale detail of the occluding object may track the positions of the points such that the points do not effectively sample the fine-scale detail of the occluding object. This issue may be particularly acute where the characteristic speed at which the points move between frames is not significantly higher than the speed at which the occluding object moves.

One way to make the variation of point positions sufficiently complex to mitigate the problem described above is for the positions of the points to vary between image frames in dependence on an output of a random, pseudorandom, or quasi-random number generator. Although the contribution from any single image frame will be subject to noise, provided the points depend on the number generator in a suitable manner, the accuracy of the viewability estimate will statistically increase with the number of image frames. In one example, the position of each point may be sampled independently from anywhere on the surface for each image frame. In a further example, the surface may be divided into multiple regions distributed substantially evenly across the surface of the object, for example as a grid with each grid square (or other shape depending on the type of grid) corresponding to a region. For each image frame, a point may then be sampled independently from each of the determined regions, ensuring that the density of points may be approximately even across the surface for each image frame, which may reduce the number of image frames required to achieve an accurate viewability estimate compared with randomly sampling points over the entire surface.

Random numbers may be generated by a hardware random number generator. Alternatively, a pseudorandom number generator or deterministic random bit generator (DRBG) can generate a sequence of numbers which approximates a sequence of truly random numbers but is completely determined by an initial seed value. Despite not generating truly random numbers, pseudorandom number generators are straightforward to implement in software and can generate numbers at a high rate with low computational cost. A quasi-random number generator is similar to a pseudorandom number generator but generates a low discrepancy sequence of numbers for which the proportion of terms in the sequence falling in a subinterval is approximately proportional to the length of the subinterval, or in other words the sequence approximates an equidistributed or uniformly distributed sequence. In the context of the present disclosure, a quasi-random number generator can be used to generate sets of points whose union over multiple image frames is substantially evenly distributed across the surface of the object. An example of a low discrepancy sequence on which a quasi-random number generator can be based is a Halton sequence.

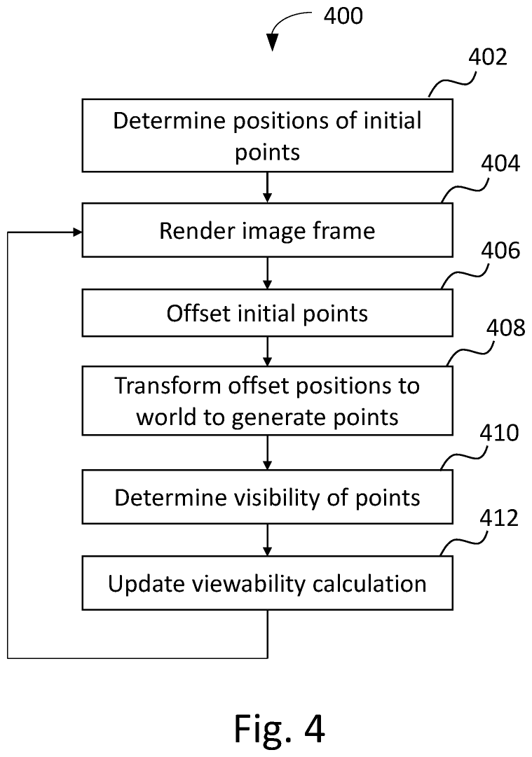

FIG. 4 shows an example of a method 400, which is an implementation of the method 300 of determining an extent to which an object is visible from a perspective of a virtual camera. The method proceeds with determining, at 402, positions of initial set of points distributed substantially evenly across a surface of the object. The initial set of points may be generated in two-dimensions in the case of a flat surface, for example using linear interpolation and, if necessary, dividing the surface into rectangular and/or triangular subregions. The initial set of points may extend to the edges of the surface or may leave a border of no points at the edge of the surface.

In an example in which the surface is a quadrilateral, the positions of the initial points may be determined in two dimensions using the following algorithm (written in pseudocode, which is to be understood to be illustrative and not prescriptive):

```
Vector2lerp(a: vector2, b: vector2, t: scalar) = a + (b − a) * t
p00, p10, p01, p11 = the four corners of the quadrilateral in two
dimensions
points = [ ]
for x in [0; count_x)
{
  for y in [0; count_y)
  {
    fx = (x + 0.5) / count_x
    fy = (y + 0.5) / count_y
    point = vector2lerp(
      vector2lerp(p00, p10, fx),
      vector2lerp(p01, p11, fx), fy)
    points = points.append(point)
  }
}
```

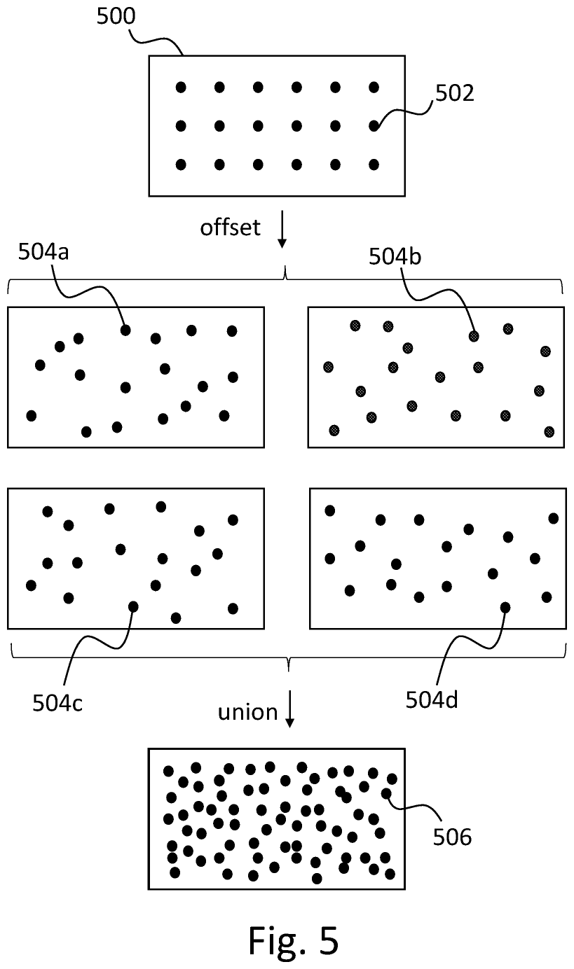

The values count_x and count_y above represent the number of columns and rows of points respectively and may be scaled e.g. in accordance with an edge width of the quadrilateral to ensure more points are generated for larger objects. These values may additionally, or alternatively, be scaled depending on distance of the object from the virtual camera, such that more points are generated for closer objects which occupy a higher proportion of the viewport. As a further alternative, the positions of the initial points may be determined within a default box (for example, the square [−1;1]², in which case the positions of the initial points may be given by [2*fx −1, 2*fy−1]). FIG. 5 shows an example of a rectangular surface 500 with an initial set of initial points 502 generated in two dimensions according to the linear interpolation algorithm above.

The method 400 proceeds with rendering, at 404, an image frame containing a view of a scene from the perspective of the virtual camera. The method 400 continues with offsetting, at 406, the initial points in directions parallel to the surface of the object. Advantageously, the directions and/or magnitudes of the offsets may differ for at least some of the initial points in order to mitigate the possibility of the offsets correlating with motion of an occluding object. Preferably, the offsetting should not be biased in any particular direction, as this may introduce systematic error in the viewability estimate. The offsetting may for example vary in dependence on outputs of a random, pseudorandom, or quasi-random number generator such as a Halton sequence generator (for example, offsets in the horizontal and vertical directions may be sampled independently for each point). The distances of the offsets may be limited (either using a hard constraint or by making larger distances statistically unlikely), for example to be less than the spacing between the initial points or half of the spacing between the initial points such that the density of points will be approximately even across the surface for each image frame, which may reduce the number of image frames required to achieve an accurate viewability estimate. In the example of FIG. 5, the initial points 502 are offset randomly and independently for each of four consecutive image frames to generate sets of offset points 504a, 504b, 504c and 504d. It is observed that there are only small variations in the density of points 506 in the union of the sets of offset points 504a, 504b, 504c and 504d. As the number of image frames increases, the union of all of the generated points will tend towards being evenly distributed across the surface.

The method 400 proceeds with transforming, at 408, the offset points to co-ordinates within the scene in dependence on the position and orientation of the virtual camera within the scene, thereby to generate a set of points for use in viewability testing. This operation may involve transforming the positions of the points from two-dimensional coordinates (e.g. planar coordinates within the surface or within a default box) to three-dimensional world space coordinates, or otherwise transforming from a model space to world space. It is to be noted that, whilst in the present example the transformation is performed after the offsetting, the offsetting may alternatively be performed after the transformation (in directions parallel to the surface in world space), or the offsetting and transforming may be performed in a single operation.

The method 400 proceeds with determining, at 410, which of the points of the set of points generated at 408 are visible from the perspective of the virtual camera, and updating, at 412, a viewability calculation. These steps may correspond substantially to steps 306 and 308 of the method 300 described above with reference to FIG. 3. As explained above, the determining of which points are visible may be performed in two stages, namely a field of view test followed by a point occlusion test. In some examples, the field of view test may be performed before the offsetting of the points such that points lying outside the field of view of the virtual camera are discarded prior to the offsetting. In this way, the offsetting is prevented from causing errors in the field of view test, for which varying point positions is unnecessary because the field of view test is not affected by fine-scale detail.

The method 400 returns to 404 and continues iteratively, with different offsets being applied to the set of initial points at each iteration. Although the present example shows the positions of the initial points being determined once as an initial step, in other implementations the positions of the initial points may be recomputed at each iteration, either in two-dimensions or directly in world space (in which case the same linear interpolation algorithm may be used with vectors in three-dimensions).

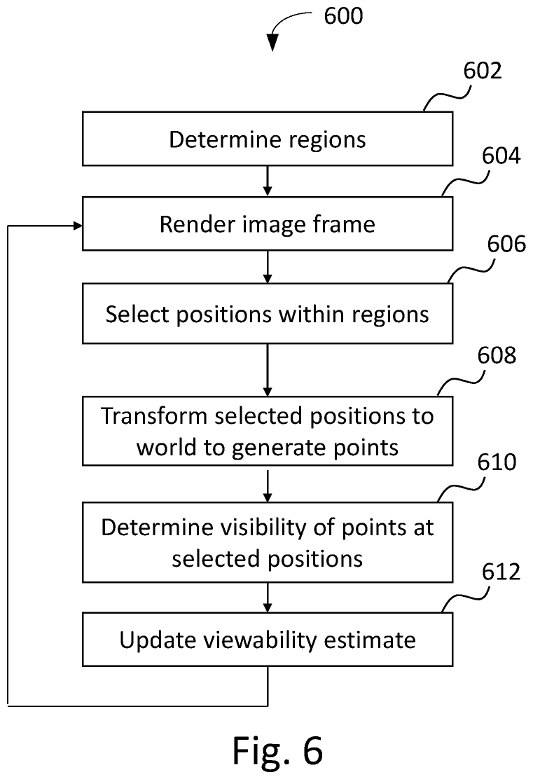

FIG. 6 shows an example of a method 600, which is a further implementation of the method 300 of determining an extent to which an object is visible from a perspective of a virtual camera. The method 600 proceeds with determining, at 602, a set of regions distributed substantially evenly across the surface of the object. The surface may for example be divided into regions by a square grid or any other regular grid.

The method 600 continues with rendering, at 604, an image frame from the perspective of the virtual camera and selecting, at 606, one or more positions within each region. The position(s) within each region may be determined in dependence on an output of a random, pseudorandom or quasi-random number generator, for example by independently sampling co-ordinates within the region. Alternatively, each region may include a set of candidate positions, for example arranged on a sub-grid within the region, and these candidate positions may be selected in a predetermined order from one image frame to the next. The selected candidate positions may be the same for all of the regions, or may be different for different regions. For example, the order at which the candidate points are selected may be different for different regions, or may be the same but with different temporal offsets or lags introduced such that for a given image frame, the selected positions within the different regions do not all correspond. For a given region, the candidate positions may be selected cyclically, meaning that over multiple cycles each candidate position will be visited approximately the same number of times.

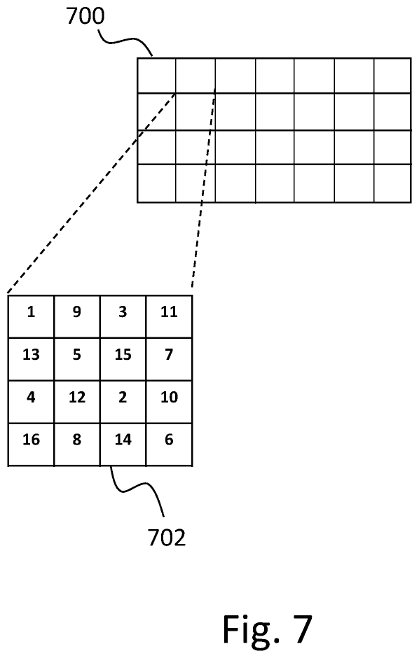

FIG. 7 shows an example of a surface 700 divided into regions using a square grid, where each region corresponds to a grid square of the grid. A grid square 702 is shown enlarged, along with a sub-grid containing sixteen sub-grid squares. In this example, the center of each sub-grid square is a candidate position for a point. The candidate positions are selected in an order corresponding to the order of the labels 1 to 16 shown in the sub-grid squares. In this example, the labelling corresponds to an (unnormalized) ordered dithering matrix or Bayer matrix, in which the labels are advantageously interleaved such that the resulting positions do not move in an ordered fashion. It will be appreciated that many other matrices or labelling systems may be used. The order in which points are selected in other grid squares of the surface 700 may be different from that of the grid square, or may be temporally offset.

The method 600 continues with transforming, at 608, the selected positions to co-ordinates within the scene in dependence on the position and orientation of the virtual camera within the scene, thereby to generate a set of points for use in viewability testing. The method 600 continues with determining, at 610, which of the points of the set of points generated at 608 are visible from the perspective of the virtual camera, and updating, at 612, a viewability calculation. These steps substantially correspond to steps 306 and 308 of the method 300 described above with reference to FIG. 3. The method 600 returns to 604 and continues iteratively, with different positions being selected at different iterations.

In some examples, an object for which viewability testing is to be performed may correspond to at least part of one or more polygons within a computer-generated scene (for example, an advert will typically be painted onto an object within the scene). In this case, sampling errors caused by the finite size of pixels, along the limited precision at which depth calculations may be performed, may result in an erroneous determination that one or more points generated for testing the viewability of the surface is further from the virtual camera than the corresponding part of the surface, and accordingly that the point is occluded when the surface is in fact visible from the perspective of the virtual camera. In order to avoid this, the positions of the generated points may be offset slightly in a direction towards the virtual camera, or alternatively in a substantially outward direction with respect to the surface (for example, parallel or approximately parallel to the outward-facing normal). In this way, points lying within a surface corresponding to one or more rendering primitives in the scene will not be erroneously determined to be occluded due to the presence of the rendering primitives.

In cases where the points are generated across one or more test polygons that match or approximate a surface formed of set of rendering polygons, the offsetting of the points away from the surface may be achieved by offsetting the test polygons from the rendering polygons before the points are generated, or alternatively the offsetting may be performed as part of the process of generating the points. The offsetting may vary in dependence on the distance of the points and/or the surface from the virtual camera. For example, points more distant from the virtual camera may be offset by a greater amount than points closer to the virtual camera, reflecting the observation that depth map values may have a higher absolute precision closer to the camera (e.g. resulting from floating point numbers being used in the depth buffer and/or resulting from range remapping and quantization of depth values). The degree of offsetting may for example be proportional to the distance of the point from the near plane. The exact dependence may vary depending on the type of depth buffer used in a particular video game (for example, integer vs floating point depth buffer).

A possible side effect of the offsetting of points away from a surface being tested is that if the surface is in or very close to the near plane, the points may be moved closer to the camera than the near plane of the virtual camera. The field of view is typically defined as being a region between the near plane and the far plane of the camera, and not lying outside of the edges of the viewport. By offsetting points such that the offset points are closer to the camera than the near plane, the points may be determined erroneously not to be visible from the perspective of the virtual camera. An example of a situation in which a game developer may position objects very close to the near plane is when information is presented in the foreground of the scene, for example as part of a user interface such as a heads-up display or dashboard. Such foreground objects may be two-dimensional or have two-dimensional portions, and it may be desirable to place such objects as close to the near plane as possible to ensure the objects are never occluded by other objects which are intended to be behind the foreground objects. Another situation where a developer may place an object in or very close to a near plane is when the virtual camera is an orthographic camera. In this case, the size of an object is independent of its distance from the camera so there is freedom for the developer to choose the distances to objects/layers, and it is common for the developer to place the nearest objects/layers in or very near to the near plane.

To mitigate the effects described above, the points may be prohibited from being offset to positions closer to the virtual camera than the near plane. For example, if the near plane defines z=0 in the depth direction in clip space (as would typically be the case for rendering as implemented in Direct3D), the z-component of each test point undergoes the operation max(z,0) →z, so that a test point with a negative z value (i.e. a test point closer to the camera than the near plane) is moved to z=0, (i.e. into the near plane). Similarly, if the near plane defines z=w in the depth direction in clip space (as would typically be the case for reverse-z rendering), the z-component of each test point undergoes the operation min(z,w)→z.

The above embodiments are to be understood as illustrative examples. Further embodiments are envisaged. For example, the viewability testing methods described herein are not limited to adverts in video games, but may be used more generally for management of digital content in any computer-generated scene, for example in virtual or augmented reality applications and/or in the metaverse.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system configured to determine an extent to which an object in a computer-generated scene is visible when viewed from a perspective of a virtual camera, the system comprising:
a point generator configured to generate, for each of a plurality of image frames in which the scene is rendered from the perspective of the virtual camera, a respective set of points distributed across a surface of the object; and
a viewability testing module configured to:
determine, for each of the plurality of image frames, which points of the respective set of points are visible from the perspective of the virtual camera; and
determine the extent to which the object is visible in dependence on which points of the respective set of points are determined to be visible in each of the plurality of image frames,
wherein the positions of at least some of the generated points relative to the surface of the object vary between the plurality of image frames.

2. The system of claim 1, wherein the positions of at least some of the generated points relative to the surface of the object vary between image frames in dependence on outputs of a random, pseudorandom, or quasi-random number generator.

3. The system of claim 1, wherein the positions of the points generated over the entirety of the plurality of image frames are substantially evenly distributed across the surface of the object.

4. The system of claim 1, wherein the point generator is configured to determine positions of a set of initial points distributed substantially evenly across the surface of the object,
wherein for each of the plurality of image frames, determining the respective set of points comprises offsetting at least some of the initial points in directions parallel to the surface of the object, the offsetting varying between the plurality of image frames.

5. The system of claim 4, wherein the offsetting varies in dependence on outputs of a random, pseudorandom, or quasi-random number generator.

6. The system of claim 1, wherein the point generator is configured to:
determine a plurality of regions distributed substantially evenly across the surface of the object; and
for each of the plurality of image frames, generate a point within each of the determined regions, thereby to generate the respective set of points,
wherein positions of the points generated within at least some of the determined regions differ between the plurality of image frames.

7. The system of claim 6, wherein;
a given region comprises a plurality of candidate positions; and
the positions of points generated within the given region over the plurality of image frames are determined by selecting the plurality of candidate positions in a predetermined order.

8. The system of claim 1, further comprising a rendering engine configured to render the computer-generated scene from the perspective of the virtual camera for each of the plurality of image frames, the rendering comprising storing, in a depth buffer, depth map data corresponding to a depth map of at least part of the computer-generated scene and comprising depth map values at pixel locations spanning at least part of a field of view of the virtual camera,
wherein for each of the plurality of image frames, for each point of the respective set of points lying within said at least part of a field of view of the virtual camera, the viewability testing module is configured to:
determine a respective depth map value for the point from the perspective of the virtual camera; and
determine, using the depth map data stored in the depth buffer, whether the point is visible from the perspective of the virtual camera based on a comparison between the determined depth map value for the point and a corresponding one or more of the depth map values stored in the depth buffer.

9. The system of claim 1, wherein for each of the plurality of image frames, for each point of the respective set of points lying within at least part of a field of view of the virtual camera, the viewability testing module is configured to:
generate a ray from the virtual camera through the point; and
determine whether any object in the scene lies on the ray between the virtual camera and the point, thereby to determine whether the point is visible from the perspective of the virtual camera.

10. The system of claim 1, wherein determining the extent to which the object is visible comprises accumulating, over the plurality of image frames, values proportional to a number of points determined to be visible in each image frame.

11. The system of claim 1, wherein determining which points of the respective set of points are visible from the perspective of the virtual camera comprises:
discarding points in the respective set of points lying outside a field of view of the virtual camera; and
determining which remaining points after the discarding are not occluded by further objects in the scene.

12. The system of claim 1, wherein for each of the plurality of image frames, the point generator is configured to:
generate a respective initial set of points distributed substantially evenly across the surface of the object;
discard points in the respective initial set of points lying outside the field of view of the virtual camera; and
offset any remaining points of the initial set of points in directions parallel to the surface of the object, thereby to generate the respective set of points.

13. The system of claim 1, wherein the point generator is configured to offset the points from the surface of the object in a direction towards the virtual camera or in a substantially outward direction with respect to the surface of the object.

14. The system of claim 13, wherein the offsetting is by a distance that increases with distance of the point from the virtual camera.

15. The system of claim 13, wherein the point generator is prohibited from offsetting points to positions closer to the virtual camera than a near plane of the virtual camera.

16. A computer-implemented method of determining an extent to which an object in a computer-generated scene is visible when viewed from a perspective of a virtual camera, the method comprising:
generating, for each of a plurality of image frames in which the scene is rendered from the perspective of the virtual camera, a respective set of points distributed across a surface of the object;
determining, for each of the plurality of image frames, which points of the respective plurality of points are visible from the perspective of the virtual camera; and
determining the extent to which the object is visible in dependence on which points of the respective set of points are determined to be visible in each of the plurality of image frames,
wherein the positions of at least some of the generated points relative to the surface of the object vary between the plurality of image frames.

17. A non-transient storage medium comprising instructions which, when executed by a computer, cause the computer to carry out a method of determining an extent to which an object in a computer-generated scene is visible when viewed from a perspective of a virtual camera, the method comprising:
generating, for each of a plurality of image frames in which the scene is rendered from the perspective of the virtual camera, a respective set of points distributed across a surface of the object;
determining, for each of the plurality of image frames, which points of the respective set of points are visible from the perspective of the virtual camera; and
determining the extent to which the object is visible in dependence on which points of the respective set of points are determined to be visible in each of the plurality of image frames,
wherein the positions of at least some of the generated points relative to the surface of the object vary between the plurality of image frames.
